(19) United States
(12) Patent Application Publication
(10) Pub. No.: US 2026/0329942 A1
(43) Pub. Date: Oct. 22, 2026

(54) SYSTEM AND METHOD FOR PERFORMING A FAST LIMITED CHARACTER SEARCH

(71) Applicant: Visa International Service Association, San Francisco, CA (US)

(72) Inventor: ADAM RATICA, MENTOR, OH (US)

(73) Assignee: Visa International Service Association, San Francisco, CA (US)

(21) Appl. No.: 19/122,903

(22) PCT Filed: Oct. 26, 2022
(86) PCT No.: PCT/US22/47950

§ 371 Date: Apr. 21, 2025

(51) Int. Cl. G06F 16/903

(52) U.S. Cl. CPC G06F 16/90344

(57) ABSTRACT

In some embodiments, a system includes a processor and a non-transitory computer readable medium coupled to the processor. In some embodiments, the non-transitory computer readable medium includes code that performs a first character assessment of a first character located at a first position in a character string, and during a search for a character subset in the character string, determines whether to bypass a character assessment of each character located in a search length span of the character string based upon the first character assessment of the first character located at the first position in the character string. In some embodiments, the non-transitory computer readable medium includes code that bypasses the character assessment of each character in the search length span when the first character is of a second type (e.g., not of a first type).

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Developing techniques that prevent data loss efficiently and effectively is vital in cloud-based computer systems of today. In order to perform data loss prevention effectively, it is often necessary to conduct search operations on vast amounts of data. The vast amounts of data may include, for example, account numbers, social security numbers, and driver's license numbers associated with the banking accounts and credit card accounts of customers. Current techniques used to search the vast amounts of data often take a significant amount of time and computation power. Therefore, a need exists to develop systems that minimize the amount of time associated with the search process, as well as the amount of power used to perform the search operations.

### BRIEF DESCRIPTION OF THE DRAWINGS

FIG. 1 illustrates a block diagram of a system in accordance with some embodiments.

FIG. 2 illustrates a block diagram of a character subset search unit utilized in the system of FIG. 1 in accordance with some embodiments.

FIG. 3 is a flow diagram illustrating a method for bypassing a character subset search and character assessments performed during a character subset search in accordance with some embodiments.

FIG. 4 illustrates a portion of a character string used to exemplify the method of FIG. 3 in accordance with some embodiments.

FIG. 5 illustrates a portion of a character string used to exemplify the method of FIG. 3 in accordance with some embodiments.

FIG. 6 illustrates a portion of a character string used to exemplify the method of FIG. 3 in accordance with some embodiments.

### DETAILED DESCRIPTION

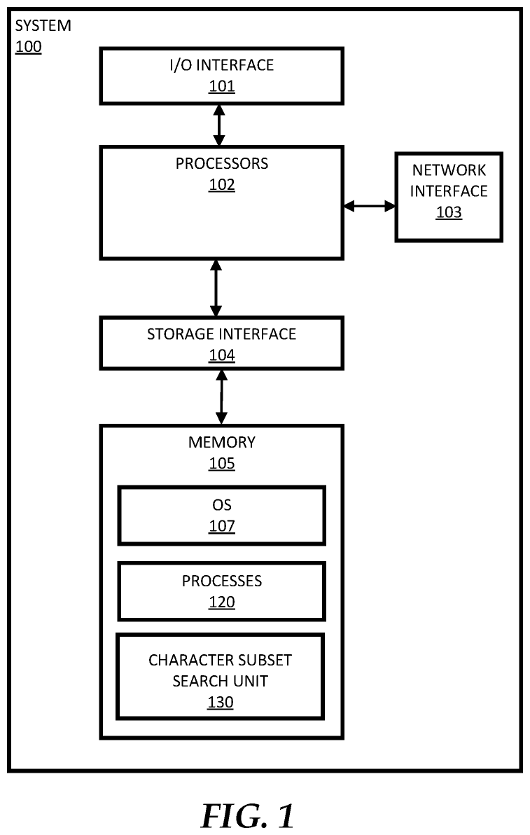

FIG. 1 illustrates a block diagram of an exemplary system 100 for implementing embodiments consistent with the present disclosure. In some embodiments, the system 100 includes an input/output (IO) interface 101, processor/s 102, a network interface 103, a storage interface 104, and memory 105. In some embodiments, memory 105 may include an operating system (OS) 107, processes 120, and a character subset search unit 130. In some nonlimiting embodiments or aspects, the system 100 may utilize the character subset search unit 130 to implement a method for performing a fast limited character search as described further herein.

In some embodiments, the processors 102 may comprise at least one data processor for executing program components for dynamic resource allocation at run time. The processors 102 may include specialized processing units such as integrated system (bus) controllers, memory management control units, floating point units, graphics processing units, digital signal processing units, etc. In some embodiments, the processors 102 may be disposed in communication with one or more input/output (I/O) devices (not shown) via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 101, the system 100 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 102 may be disposed in communication with a communication network or other type of network via a network interface 103. The network interface 103 may communicate with the communication network. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network, the system 100 may communicate with the one or more service operators.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, the memory 105 may store a collection of program or database components, including, without limitation, a user interface, an operating system 107, a web server, etc. In some non-limiting embodiments or aspects, the system 100 may store user/application data, such as the data, variables, records, etc. as described in this disclosure.

Such databases may be implemented as fault-tolerant, relational, scalable, secure databases such as Oracle or Sybase.

In some embodiments, the operating system 107 may facilitate resource management and operation of the system 100. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLETM ANDROID™, BLACKBERRY® OS, or the like.

In some non-limiting embodiments or aspects, the system 100 may implement a web browser (not shown in the figures) stored program component. The web browser (not shown in the figures) may be a hypertext viewing application, such as MICROSOFT® INTERNET EXPLORER®, GOOGLETM CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

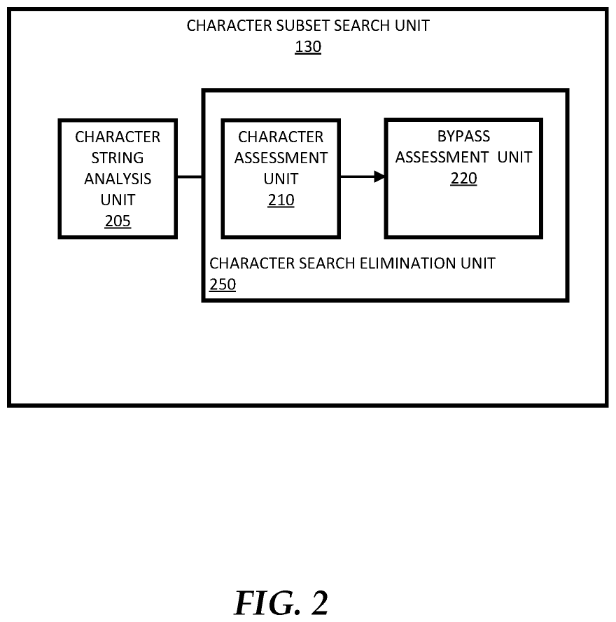

FIG. 2 illustrates a character subset search unit 130 of FIG. 1 in accordance with some embodiments. In some embodiments, character subset search unit 130 is executable code configured to eliminate unnecessary character subset searches and character assessments during a search for character subsets in a character string. In some embodiments, the character string is a series of characters used by a computer system that are numeric (e.g., digits) or not numeric (e.g., letters, punctuation) and may include, for example, personal account numbers (PANs), social-security numbers, bank account numbers, or other types of characters used to conduct financial transactions. In some embodiments, the character string may be a linear grid of characters and may be stored in, for example, memory 105 or a cloud system electronically or wirelessly coupled to system 100. In some embodiments, the character string may be numeric, non-numeric, or combination of numeric and non-numeric characters. In some embodiments, a character subset is a predefined subset of characters in the character string that may be searched for by the character subset search unit 130. In some embodiments, the character subset may be predefined as having a specific type of characters, e.g., a first type (e.g., a numeric type) or a second type (e.g., a non-numeric type). In some embodiments, the character subset may be predefined as having multiple types of characters. In some embodiments, the character subsets being searched for by character subset search unit 130 may be predefined as a first type, although one may appreciate that the methods described herein may be utilized to search for character subsets of a second type. In some embodiments, the character subset may be predefined by character subset search unit 130 of system 100 or the user of system 100 as, for example, a PAN, a social security number, a driver's license number, or some other predefined subset of characters. In some embodiments, the characters or character subsets in the character string may be itemized in a log or a set of logs used in, for example, data loss prevention or the like, and stored in memory 105.

In some embodiments, character subset search unit 130 includes a character string analysis unit 205 and a character search elimination unit 250. In some embodiments, the character string analysis unit 205 is executable code configured to analyze a character string received by the character subset search unit 130. In some embodiments, for example, character string analysis unit 205 is configured to determine a character string length (e.g., the number of characters in the character string). In some embodiments, the character string length is utilized by character subset search unit 130 to limit the duration of character subset searches performed by character subset search unit 130 to the length of the character string. In some embodiments, character search elimination unit 250 is executable code configured to perform a character assessment of characters in the character string and eliminate, limit, and reduce unnecessary character subset searches and unnecessary character assessments of characters in the character string.

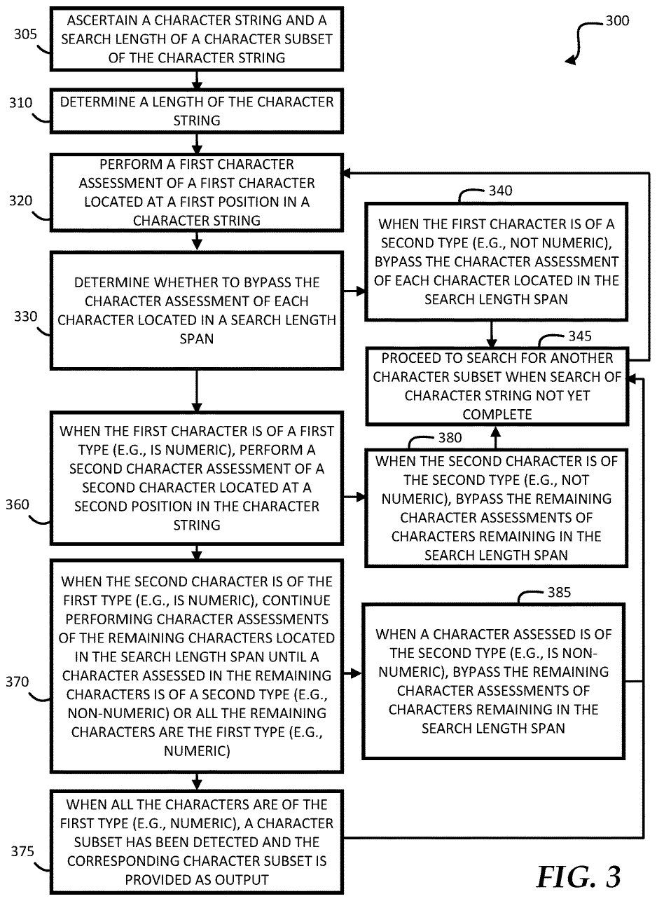

In some embodiments, character search elimination unit 250 includes a character assessment unit 210 and a bypass assessment unit 220. In some embodiments, character assessment unit 210 is executable code configured to determine whether a character in a character string is of a specific type, e.g., a first type (e.g., a numeric type) or a second type (e.g., not a numeric type). In some embodiments, bypass assessment unit 220 is executable code configured to utilize the character assessment performed by the character assessment unit 210 to bypass or eliminate unnecessary character subset searches and unnecessary character assessments of characters in the character string. In some embodiments, the use of character subset search unit 130 in system 100, which may be, for example, in a data loss prevention system, is an improvement over traditional data loss prevention systems in that use of the character subset search unit 130 reduces the amount of search time required to search for a character subset in a character string by, for example, bypassing the assessment of characters within the character string that do not form, make up, or map to a character subset, as illustrated and described below with reference to FIG. 3.

FIG. 3 is a flow diagram illustrating a method 300 for bypassing a character subset search and character assessments during a search for character subsets in a character string in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the method 300 is described with reference to the figures described herein.

In some embodiments, in order to commence the process of searching a character string for a character subset or character subsets located within the character string, at operation 305, character string analysis unit 205 of character subset search unit 130 ascertains the character string and a search length of the character subset from, for example, memory 105. In some embodiments, as stated previously, the character string is a series of characters that may be of a first type (e.g., numeric (e.g., digits)) or a second type (e.g., not numeric (e.g., letters, punctuation)) and may include a character subset or plurality of character subsets, such as, for example, a PAN, a social security number, a driver's license number, or other type of character subset. In some embodiments, as stated previously, the character subset may be predefined as a subset of characters of the first type (e.g., numeric) or as a subset of characters of the second type (e.g., non-numeric), depending on, for example, the type of character subsets being searched for in the character string by character subset search unit 130. In some embodiments, for example, when the character subset search unit 130 is searching the character string for sixteen-digit PANs, then the character subset is a PAN of numeric type and the search length of the character subset is sixteen. Similarly, in some embodiments, for example, when the character subset search unit 130 is searching the character string for nine-digit social security numbers, then the character subset is a social security number of numeric type and the search length of the character subset is nine. In some embodiments, other character subsets may be designated with varying search lengths. In some embodiments, character subset search unit 130 may be configured to search for a single type of character subset, such as, for example, a PAN type character subset search, or a social security number type character subset search.

In some embodiments, the search length of the character subset is a length of the character subset that is being searched for by character subset search unit 130 (e.g., the number of characters of the character subset being searched for by character subset search unit 130). In some embodiments, the search length may be provided by, for example, a user of the character subset search unit 130 of system 100 or may be provided by the system 100. In some embodiments, the system 100 may store a specific search length that is associated with the type of character subset being searched for by character subset search unit 130 and may not require a user to provide the search length. In some embodiments, for example, for a PAN character subset, system 100 may store a search length of sixteen that is associated with the PAN character subset. In some embodiments, after the character string and search length have been ascertained by character string analysis unit 205, character subset search unit 130 proceeds to operation 310.

In some embodiments, at operation 310, character string analysis unit 205 determines a length of the character string provided to the character subset search unit 130. In some embodiments, character string analysis unit 205 is configured to determine the length of the character string by utilizing a specialized function, such as, for example, a length function (e.g., Length(String)), from a computer programming language, such as, for example, Python or the C++. In some embodiments, as described herein, the length of the character string may be used by the character subset search unit 130 to limit the duration of character subset searches to the length of the character string. In some embodiments, after determining the character string length at operation 310, character subset search unit 130 proceeds to operation 320.

In some embodiments, at operation 320, character assessment unit 210 of character search elimination unit 250 performs a first character assessment of a first character located at a first position (e.g., a first character position) in the character string. In some embodiments, the character assessment is an assessment or determination made by character assessment unit 210 of the type of character located at a specified character position in the character string (e.g., whether a character at the first position is of a first type (e.g., numeric) or a second type (non-numeric)). In some embodiments, as described herein, the character assessment unit 210 is configured to assess characters in the character string that are used by the character subset search unit 130 to determine whether to bypass or limit unnecessary character searches, character subset searches, or character assessments of characters in the character string during the search for character subsets in the character string to save time and processing power in system 100.

In some embodiments, in order to perform the character assessment at character assessment unit 210, character subset search unit 130 ascertains the position or positions of the characters to be assessed by the character assessment unit 210. In some embodiments, the position of the first character (e.g., the first position or first character position) to be assessed by the character assessment unit 210 may be represented by a character subset search index. In some embodiments, the character subset search index is an index that is used to provide an initial character assessment position for an initial character assessment of a character in a potential character subset and subsequent initial character assessment positions of initial character assessments of characters in subsequent potential character subsets during a search for character subsets in the character string. In some embodiments, the potential character subset is a subset of characters in the character string that may be a character subset but have yet to be designated as such by character subset search unit 130. In some embodiments, the character subset search index is a function of the search length of the character subset ascertained at operation 305 and the index value itself. For example, in some embodiments, the character subset search index may be represented as i=i+search length, where the initial value of i is the search length and subsequent values of i are a summation of i and the search length. For example, in some embodiments, for a search for a PAN with a search length of sixteen, the initial value of i is sixteen and a subsequent character subset search index (e.g., the subsequent first position of an initial character assessment in a subsequent character subset search) is thirty two, etc. (e.g., i=sixteen+sixteen=thirty two). In alternate embodiments, other initial index values may be utilized as index values by character subset search unit 130 and incremented accordingly based on the search length provided to character subset search unit 130. In some embodiments, the position indicated by the character subset search index is used by character assessment unit 210 to perform the character assessment of the character located at the character subset search index.

In some embodiments, after ascertaining the location of the first position of the character to be assessed in the character string, the character assessment unit 210 performs the first character assessment of the first character located at the first position. In some embodiments, character assessment unit 210 performs the first character assessment by determining whether the first character located at the first position is of the first type (e.g., numeric) or the second type (e.g., non-numeric). In some embodiments, character assessment unit 210 is configured to determine whether a character in the character string is of the first type (e.g., numeric) or second type (e.g., not numeric) by utilizing a specialized function, such as, for example, an isNumeric function, from a computer programming language, such as, for example, Python or the C++. In some embodiments, character assessment unit 210 is configured to determine whether a character in the character string is of the first type (e.g., numeric) or the second type (e.g., not numeric) by comparing the character in the character string to a sequence of characters stored in, for example, memory 105, that are defined as either the first type (e.g., numeric) or the second type (e.g., not numeric). In some embodiments, the sequence of characters and/or character types used for comparison purposes during character assessment may be stored in other types of memory associated with system 100. In some embodiments, after performing the first character assessment at operation 320, character assessment unit 210 provides the result of the character assessment to bypass assessment unit 220 at operation 330.

In some embodiments, at operation 330, using the result of the assessment made by character assessment unit 210, bypass assessment unit 220 determines whether to bypass a character assessment of each character located in a search length span of a potential character subset of the character string. In some embodiments, the search length span is the span of character positions that correspond to the span of index values from, but not including, an end position of a potential character subset to a beginning position of the potential character subset. In some embodiments, as described previously herein, the potential character subset is a subset of characters in the character string that may be a character subset but have yet to be designated as such by character subset search unit 130. In some embodiments, for example, for a sixteen digit potential PAN that is located at the beginning of a character string from positions one to sixteen, the search length span extends from position fifteen (e.g., from, but not including, the end position of the potential character subset) to position one (e.g., the beginning position of the potential character subset).

In some embodiments, the bypass assessment unit 220 determines whether to bypass a character assessment of each character located in the search length span by performing a character type analysis of the first type of character assessed by the character assessment unit 210. In some embodiments, in order to perform the character type analysis, bypass assessment unit 220 evaluates the result of the first character assessment output by character assessment unit 210 to determine if the resulting output is of the first type (e.g., numeric) or second type (e.g., non-numeric). In some embodiments, bypass assessment unit 220 is configured to perform the character type analysis by comparing the output of the character assessment unit 210 to character types stored in, for example, memory 105, that are either the first type (e.g., numeric) or the second type, (e.g., non-numeric). For example, in some embodiments, when, based on the upon the comparison to the stored character types, bypass assessment unit 220 makes the determination that the result of the first character assessment output by character assessment unit 210 is of the first type (e.g., numeric), bypass assessment unit 220 makes the determination to not bypass the character assessment of each character located in the search length span and proceeds to operation 360. In some embodiments, when, based on the upon the comparison to the stored character types, bypass assessment unit 220 makes the determination that the result of the first character assessment output by character assessment unit 210 is of the second type (e.g., non-numeric), bypass assessment unit 220 makes the determination to bypass the character assessment of each character located in the search length span and proceeds to operation 340.

In some embodiments, at operation 340, when bypass assessment unit 220 determines that the first character assessment performed by character assessment unit 210 has yielded a determination that the first character is of the second type (e.g., non-numeric), bypass assessment unit 220 notifies character assessment unit 210 to bypass the character assessment of each character located in the search length span. In some embodiments, based on the bypass assessment and notification received from bypass assessment unit 220, character assessment unit 210 bypasses the character assessment of each character located in the search length span. In some embodiments, character assessment unit 210 bypasses the character assessment of each character located in the search length span by using the character subset search index. For example, in some embodiments, character assessment unit 210 bypasses the character assessment of each character located in the search length span by advancing to the position in the character string that is indicated by the character subset search index that has been increased by the search length (e.g., the subsequent character subset search index), thereby eliminating the need for a character subset search of the characters in the search length span. In some embodiments, after bypassing the character assessment of each character located in the search length span, operation 340 advances to operation 345, and character subset search unit 130 proceeds to search for another character subset from, for example, a new first position or new initial character assessment position (e.g., subsequent initial character assessment position) in a new potential character subset in the character string dictated by the subsequent character subset search index.

In some embodiments, at operation 360, when bypass assessment unit 220 determines that the first character assessment performed by character assessment unit 210 has yielded a determination that the first character is of the first type (e.g., numeric), bypass character assessment unit 210 does not bypass a character assessment of each character located in the search length span, but instead, proceeds to perform a second character assessment of a second character located at a second position in the character string. In some embodiments, the second position of the second character of a potential character subset of the character string and subsequent character assessment positions in the potential character subset are defined by a subsequent character assessment position. In some embodiments, the subsequent character assessment position is an index that is equal to a search length variable subtracted from the search length of the character subset being searched for by character subset search unit 130 (e.g., subsequent character assessment position=search length−search length variable). In some embodiments, the search length variable is a variable used by the subsequent character assessment position to index through the search length span of a potential character subset to perform a character assessment. In some embodiments, the search length variable may be an integer value ranging from one up to, but not including, the search length. In some embodiments, for example, when the search length variable is set initially to a value of fifteen for a sixteen digit PAN, the subsequent character assessment position is one (e.g., subsequent character assessment position=sixteen−fifteen=one). In some embodiments, after the position of the second character is determined by character assessment unit 210, character assessment unit 210 proceeds to perform a character assessment of a second character at operation 360 as described further herein. In some embodiments, the techniques described herein may also be applied to a zero-based programming language, e.g., where the locations of characters in, for example, a sixteen character subset, may be identified such that the first character is identified as string[0] and the sixteenth character is identified as string[15].

In some embodiments, at operation 360, after ascertaining the second position character using the subsequent character assessment position, character assessment unit 210 performs the second character assessment of the character located at the second position by determining whether the second character is of the first type (e.g., numeric) or the second type (e.g., non-numeric). In some embodiments, character assessment unit 210 is configured to determine whether a character in the character string is of the first type (e.g., numeric) or second type (e.g., not numeric) by utilizing a specialized function, such as, for example, an isNumeric function, from a computer programming language, such as, for example, Python or the C++. In some embodiments, alternate functions may be utilized to determine whether a character in the character string is of the first type (e.g., numeric) or second type (e.g., not numeric). In some embodiments, the character type of the second character located at the second position is stored in, for example, memory 105 or other type of memory associated with system 100. In some embodiments, after performing the second character assessment of the character located at the second position, operation 360 proceeds to operation 370 or operation 380, depending on the whether the result of the character assessment performed by character assessment unit 210 is of the first type (e.g., numeric) or second type (e.g., non-numeric).

In some embodiments, at operation 380, when the second character located at the second position is of the second type (e.g., not of the first type (e.g., non-numeric)), bypass assessment unit 220 notifies character assessment unit 210 to bypass the remaining character assessments of the remaining characters in the search length span. In some embodiments, the remaining characters in the search length span are the characters in the search length span whose type has yet to be assessed by the character assessment unit 210. In some embodiments, for example, for a sixteen digit PAN, when there are fourteen remaining characters in the search length span (and thus fourteen remaining character assessments), bypass assessment unit 220 notifies character assessment unit 210 to bypass the remaining fourteen character assessments of characters remaining in the search length span. In some embodiments, after receiving the notification from bypass assessment unit 220, character assessment unit 210 bypasses the character assessment of each of the remaining characters located in the search length span. In some embodiments, character assessment unit 210 bypasses the character assessment of the remaining characters located in the search length span by using the character subset search index. For example, in some embodiments, character assessment unit 210 advances to the position in the character string that is indicated by the character subset search index that has been increased by the search length (e.g., the subsequent character subset search index).

In some embodiments, after bypassing the character assessment of each of the remaining characters in the search length span, operation 380 proceeds to operation 345. In some embodiments, at operation 345, character subset search unit 130 proceeds to search for another character subset using the methods described herein at a position dictated by the character search subset index.

In some embodiments, with reference to operation 370, when the second character assessed by character assessment unit 210 is of the first type (e.g., numeric), character assessment unit 210 continues performing character assessments of the remaining characters located in the search length span until a character assessed is of a second type (e.g., non-numeric) or all the characters in the search length span are of the first type (e.g., numeric). In some embodiments, at operation 385, when a character assessed by character assessment unit 210 is of a second type (e.g., non-numeric), character assessment unit 210 bypasses the remaining character assessments of the remaining characters in the search length span using the character subset search index. In some embodiments, after the remaining character assessments of the characters remaining in the search length span have been bypassed, operation 340 advances to operation 345 and proceeds to search for another character subset at a position dictated by the character subset search index.

In some embodiments, with reference to operation 375, when all the characters of the search length span assessed by character assessment unit 210 are of the first type (e.g., numeric), a character subset has been found or detected by the character subset search unit 130 and the corresponding character subset is provided as output to the character subset search unit 130. In some embodiments, operation 375 advances to operation 345 to proceed to search for a character subset at a position dictated by, for example, the character subset search index. In some embodiments, the method 300 is repeated until all the character subsets in the character string searched by system 100 are identified by character subset search unit 130.

In alternate embodiments, referring back to FIG. 3 and as exemplified below with reference to FIG. 6, at operation 360, when character assessment unit 210 has determined that the first character at the first position in the potential character subset is a character is of a first type (e.g., numeric), character assessment unit 210 performs a character assessment of the characters in the search length span immediately preceding the first position of the potential character subset until character assessment unit 210 yields a character assessment of the second type (e.g., non-numeric). In some embodiments, character assessment unit 210 then readjusts the location of the first position to the position having the character of the second type. In some embodiments, the character assessment unit 210 readjusts the location of the first position by setting the initial value of i in the character subset search index to the position having the character of the second type (e.g., non-numeric). For example, in some embodiments, for a sixteen digit PAN, if character assessment unit 210 determines that the character at the first position (e.g., position sixteen) is of the first type (e.g., numeric) and the character assessment of the characters in the search length span immediately preceding the first position are numeric up until position fourteen, then character assessment unit 210 readjusts the location of the first position to position fourteen and the subsequent character subset search index is thirty (e.g., i=fourteen+sixteen=thirty).

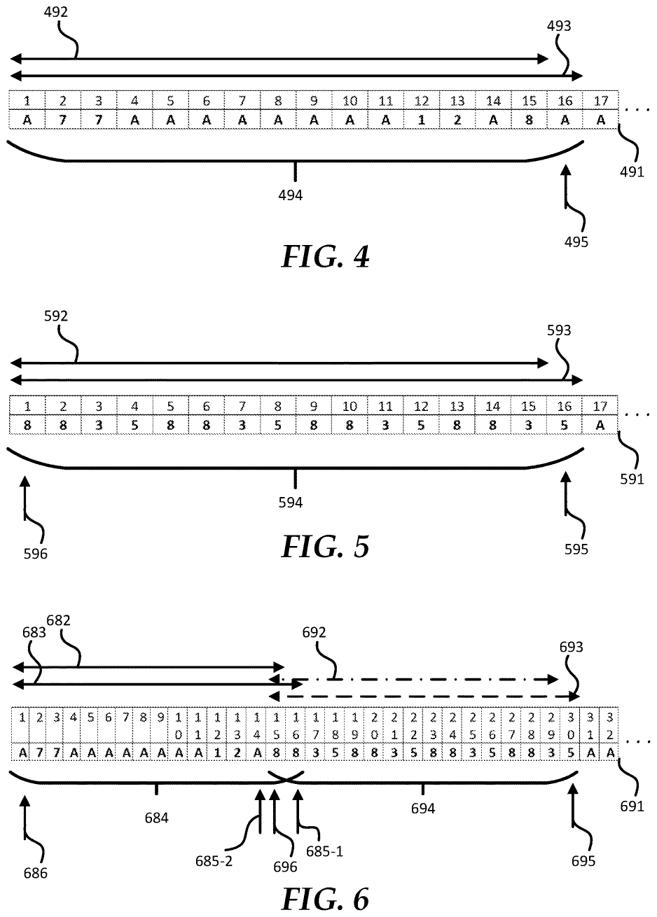

FIG. 4 illustrates a portion of a character string 491 utilized by character subset search unit 130 of FIG. 1 and FIG. 2 to exemplify the method 300 of FIG. 3 in accordance with some embodiments. In some embodiments, the method 300 is being utilized by character subset search unit 130 to search for character subsets in the character string 491. FIG. 4 includes a search length span 492, a search length 493, a potential character subset 494, and a first position 495. Although not depicted in its entirety, the character string 491 includes, in addition to non-numeric characters, numeric characters in predefined PANs as character subsets of search length sixteen. In FIG. 4, a character subset search of the potential character subset 494 has been bypassed by character assessment unit 210 during a search for PAN character subsets in character string 491. In some embodiments, the character subset search of the potential character subset 494 has been bypassed based on the character assessment of the character located at the first position 495, which is non-numeric. Thus, the character assessment unit 210 has bypassed character assessments of each and every character in search length span 492, and, as a result, bypassed a character subset search for a character subset in character string 491.

FIG. 5 illustrates a portion of a character string 591 utilized by character subset search unit 130 of FIG. 1 and FIG. 2 to exemplify the method 300 of FIG. 3 in accordance with some embodiments. In some embodiments, the method 300 is being utilized by character subset search unit 130 to search for character subsets in the character string 591. FIG. 5 includes a search length span 592, a search length 593, a potential character subset 594, a first position 595, and a second position 596. Although not depicted in its entirety, the character string 591 includes, in addition to non-numeric characters, numeric characters in predefined PANs as character subsets of search length sixteen. In FIG. 5, a character subset search of potential character subset 594 is not bypassed since, for example, the character assessment of the character at the first position 595 is numeric, the character assessment of the character at the second position is numeric, and the remaining characters in the search length span are numeric. Thus, in the example of FIG. 5, character assessment unit 210 has determined that all the characters in the potential character subset 594 are numeric and are output by character subset search unit 130 as an identified character subset.

FIG. 6 illustrates a portion of a character string 691 utilized by character subset search unit 130 of FIG. 1 and FIG. 2 to exemplify the method 300 of FIG. 3 in accordance with some embodiments. In some embodiments, the method 300 is being utilized by character subset search unit 130 to search for character subsets in the character string 691. FIG. 6 includes a search length span 682, a search length span 692, a search length 683, a search length 693, a potential character subset 684, a potential character subset 694, a first position 685-1, a readjusted first position 685-2, a second position 686, and a second position 696. In the example illustrated in FIG. 6, since the character assessment unit 210 has assessed the character at the first position 685-1 as numeric and the character assessment of the characters in the search length span 682 immediately preceding the first position 685-1 are numeric up until position fourteen, then character assessment unit 210 has readjusted the location of the first position 685-1 to the first position 685-2 (e.g., readjusted first position of fourteen) and the first position 695 of the subsequent potential character subset 694 is thirty (e.g., the subsequent character subset search index is thirty (e.g., i=fourteen+sixteen=thirty)). In some embodiments, since the character of the first position 695 is numeric, the character of the second position 696 is numeric, and the remaining characters in the search length span 692 are numeric, the potential character subset 694 is identified as a character subset (e.g., a PAN) and output by character subset search unit 130.

In some embodiments, by using the methods described herein to eliminate the need to perform unnecessary character subset searches and character assessments of characters in a character string, system 100 provides improvement over traditional data loss prevention systems in that use of the character subset search unit 130 in system 100 reduces the amount of search time and power required to search for character subsets in a character string provided to character subset search unit 130.

In alternate embodiments of the method 300 of FIG. 3, at operation 360, instead of the second position in the character string (e.g., the subsequent character assessment position) being located at the beginning of the search length span, the subsequent character assessment position may be located at the end of the search length span. For example, in some embodiments, when the character subset being searched for by character subset search unit 130 is a sixteen digit PAN, with a search length variable initially at a value of one, character assessment unit 210 performs a second character assessment of the second character located at a subsequent character assessment position value of fifteen in the search length span (e.g., the second character position is at sixteen minus one, which is equivalent to position fifteen in the search length span). In some embodiments, operation 360 then proceeds to operation 370, where when the second character is of the first type (e.g., numeric), character assessment unit 210 continues performing character assessments of the remaining characters located in the search length span until a character is assessed in the search length span is of a second type (e.g., non-numeric) or all the characters of the search length span are of the first type (e.g., numeric). In some embodiments, after operation 370, operation 370 proceeds to operation 375 or operation 385 as described previously herein.

In some embodiments, the character string length may be utilized by character subset search unit 130 to determine the number of characters examined and the efficiency of the character subset search methods described herein. In some embodiments, to determine the efficiency and the number of characters examined, character subset search unit 130 calculates a floor of the character string length divided by the search length. In some embodiments, for example, for a character string length of seventeen, and a search length of sixteen, character subset search unit 130 calculates the floor of the character string length divided by the search length as one. Thus, in some embodiments, the methods described herein are more efficient and thus improve upon computer capabilities and existing technology and search methods since, for example, the number of characters assessed utilizing the methods described herein are less than the number of characters assessed utilizing other search methods. For example, for the aforementioned example, by utilizing the bypassing techniques described herein, instead of sixteen characters being searched, only one is character being searched during a search for character subsets in the character string. In some embodiments, character string analysis unit 205 is configured to determine the floor of the character string length divided by the search length by utilizing a specialized function, such as, for example, a floor function (e.g., floor((length(character string))/search length), from a computer programming language, such as, for example, Python or the C++.

In some embodiments, a computer-implemented method, includes performing a first character assessment of a first character located at a first position in a character string; and during a search for a character subset in the character string, determining whether to bypass a character assessment of each character located in a search length span of the character string based upon the first character assessment of the first character located at the first position in the character string.

In some embodiments of the computer-implemented method, the search length span is a span of character positions spanning from, but not including, an end position of a potential character subset to a beginning position of the potential character subset.

In some embodiments, the computer-implemented method further includes, when the first character is of a second type, bypassing the character assessment of each character in the search length span.

In some embodiments, the computer-implemented method further includes, when the first character is of a first type, performing a second character assessment of a second character located at a second position in the character string.

In some embodiments, the computer-implemented method further includes, when the second character is of the second type, bypassing remaining character assessments of the characters remaining in the search length span.

In some embodiments, the computer-implemented method further includes, when the second character is of the first type, continue performing character assessments of remaining characters in the search length span until a character assessed in the remaining characters in the search length span is of the second type or all the remaining characters in the search length span are of the first type.

In some embodiments of the computer-implemented method, when the character assessed in the remaining characters in the search length span is of the second type, bypassing the remaining character assessments of the characters remaining in the search length span.

In some embodiments of the computer-implemented method, when all the remaining characters in the search length span are of the first type, the second character, all the remaining characters in the search length span, and the first character are output as a detected character subset.

In some embodiments of the computer-implemented method, a floor function is utilized to determine a number of characters assessed as a result of bypassing the remaining character assessments of the characters remaining in the search length span, the number of characters assessed as the result of bypassing the remaining character assessments of the characters remaining being utilized to determine a bypassing efficiency.

In some embodiments, a system, includes a processor; and a non-transitory computer readable medium coupled to the processor, the non-transitory computer readable medium comprising code that: performs a first character assessment of a first character located at a first position in a character string; and during a search for a character subset in the character string, determines whether to bypass a character assessment of each character located in a search length span of the character string based upon the first character assessment of the first character located at the first position in the character string.

In some embodiments of the system, the search length span is a span of character positions spanning from, but not including, an end position of a potential character subset to a beginning position of the potential character subset.

In some embodiments of the system, the non-transitory computer readable medium further comprises code that: bypasses the character assessment of each character in the search length span when the first character is of a second type.

In some embodiments of the system, the non-transitory computer readable medium further comprises code that: performs a second character assessment of a second character located at a second position in the character string when the first character is of a first type.

In some embodiments of the system, the non-transitory computer readable medium further comprises code that: bypasses remaining character assessments of the characters remaining in the search length span when the second character is of the second type.

In some embodiments of the system, the non-transitory computer readable medium further comprises code that: when the second character is of the first type, performs character assessments of remaining characters in the search length span until a character assessed in the remaining characters in the search length span is of the second type or all the remaining characters in the search length span are of the first type.

In some embodiments of the system, the non-transitory computer readable medium further comprises code that: when the character assessed in the remaining characters in the search length span is of the second type, bypasses the remaining character assessments of the characters remaining in the search length span.

In some embodiments, an apparatus includes a character assessment unit; and a bypass assessment unit coupled to the character assessment unit, wherein based upon a first character assessment of a first character in a character string by the character assessment unit, the bypass assessment unit determines whether to bypass a character assessment of each character located in a search length span from the first character in the character string.

In some embodiments of the apparatus, the bypass of the character assessment each character in the search length span occurs when the first character is non-numeric.

In some embodiments of the apparatus, the bypass of the character assessment of each character in the search length span does not occur when the first character is non-numeric character.

In some embodiments of the apparatus, when the first character is numeric, the remaining characters in the search length span are bypassed when a second character at a second position in the search length span is non-numeric.

What is claimed is:

1. A computer-implemented method, comprising:
performing a first character assessment of a first character located at a first position in a character string; and
during a search for a character subset in the character string, determining whether to bypass a character assessment of each character located in a search length span of the character string based upon the first character assessment of the first character located at the first position in the character string.

2. The computer-implemented method of claim 1, wherein:
the search length span is a span of character positions spanning from, but not including, an end position of a potential character subset to a beginning position of the potential character subset.

3. The computer-implemented method of claim 2, further comprising:
when the first character is of a second type, bypassing the character assessment of each character in the search length span.

4. The computer-implemented method of claim 3, further comprising:
when the first character is of a first type, performing a second character assessment of a second character located at a second position in the character string.

5. The computer-implemented method of claim 4, further comprising:
when the second character is of the second type, bypassing remaining character assessments of the characters remaining in the search length span.

6. The computer-implemented method of claim 5, further comprising:
when the second character is of the first type, continue performing character assessments of remaining characters in the search length span until a character assessed in the remaining characters in the search length span is of the second type or all the remaining characters in the search length span are of the first type.

7. The computer-implemented method of claim 6, wherein:
when the character assessed in the remaining characters in the search length span is of the second type, bypassing the remaining character assessments of the characters remaining in the search length span.

8. The computer-implemented method of claim 7, wherein:
when all the remaining characters in the search length span are of the first type, the second character, all the remaining characters in the search length span, and the first character are output as a detected character subset.

9. The computer-implemented method of claim 8, wherein:
a floor function is utilized to determine a number of characters assessed as a result of bypassing the remaining character assessments of the characters remaining in the search length span, the number of characters assessed as the result of bypassing the remaining character assessments of the characters remaining being utilized to determine a bypassing efficiency.

10. A system, comprising:
a processor; and
a non-transitory computer readable medium coupled to the processor, the non-transitory computer readable medium comprising code that:
performs a first character assessment of a first character located at a first position in a character string; and
during a search for a character subset in the character string, determines whether to bypass a character assessment of each character located in a search length span of the character string based upon the first character assessment of the first character located at the first position in the character string.

11. The system of claim 10, wherein:
the search length span is a span of character positions spanning from, but not including, an end position of a potential character subset to a beginning position of the potential character subset.

12. The system of claim 11, wherein the non-transitory computer readable medium further comprises code that:
bypasses the character assessment of each character in the search length span when the first character is of a second type.

13. The system of claim 12, wherein the non-transitory computer readable medium further comprises code that:
performs a second character assessment of a second character located at a second position in the character string when the first character is of a first type.

14. The system of claim 13, wherein the non-transitory computer readable medium further comprises code that:
bypasses remaining character assessments of the characters remaining in the search length span when the second character is of the second type.

15. The system of claim 14, wherein the non-transitory computer readable medium further comprises code that:
when the second character is of the first type, performs character assessments of remaining characters in the search length span until a character assessed in the remaining characters in the search length span is of the second type or all the remaining characters in the search length span are of the first type.

16. The system of claim 15, wherein the non-transitory computer readable medium further comprises code that:
when the character assessed in the remaining characters in the search length span is of the second type, bypasses the remaining character assessments of the characters remaining in the search length span.

17. An apparatus, comprising:
A character assessment unit; and
a bypass assessment unit coupled to the character assessment unit, wherein based upon a first character assessment of a first character in a character string by the character assessment unit, the bypass assessment unit determines whether to bypass a character assessment of each character located in a search length span from the first character in the character string.

18. The apparatus of claim 17, wherein:
the bypass of the character assessment each character in the search length span occurs when the first character is non-numeric.

19. The apparatus of claim 18, wherein:
the bypass of the character assessment of each character in the search length span does not occur when the first character is non-numeric character.

20. The apparatus of claim 19, wherein:
when the first character is numeric, the remaining characters in the search length span are bypassed when a second character at a second position in the search length span is non-numeric.
